(19) United States
(12) Patent Application Publication
(10) Pub. No.: US 2026/0343290 A1
(43) Pub. Date: Oct. 29, 2026

(54) MOBILITY SUPPORT FOR QUALITY OF EXPERIENCE REPORTING

(71) Applicant: Telefonaktiebolaget LM Ericsson (PUBL), Stockholm (SE)

(72) Inventors: Cecilia Eklöf, TÄBY (SE); Luca Lunardi, GENOA (IT); Agne Ciuciulkaite, UPPSALA (SE); Johan Rune, LIDINGÖ (SE)

(21) Appl. No.: 19/115,351

(22) PCT Filed: Sep. 27, 2023
(86) PCT No.: PCT/IB2023/059644

§ 371 Date: Mar. 26, 2025

Related U.S. Application Data
(60) Provisional application No. 63/410,397, filed on Sep. 27, 2022.

(51) Int. Cl. H04W 24/10; H04W 4/06; H04W 48/20; H04W 76/27

(52) U.S. Cl. CPC H04W 24/10; H04W 4/06; H04W 48/20; H04W 76/27

(57) ABSTRACT

According to some embodiments, a method is performed by a wireless device comprises: obtaining a quality of experience (QoE) configuration for QoE operations with respect to a multicast and broadcast service (MBS) in a first cell of a first network node; transitioning to an idle or inactive state; performing cell reselection to a second cell of a second network node; obtaining an indication that the second cell supports QoE operations; transitioning to a connected state; and transmitting a QoE report to the second network node in the second cell.

### TECHNICAL FIELD

Embodiments of the present disclosure are directed to wireless communications and, more particularly, to mobility support for quality of experience (QoE) reporting.

### BACKGROUND

Fifth generation (5G) New Radio (NR) is a radio access technology developed by Third Generation Partnership Project (3GPP) for the 5G mobile network. Quality of Experience (QoE) measurements, also referred to as “application layer measurements,” are specified for Long Term Evolution (LTE) and Universal Mobile Telecommunications System (UMTS), and are being specified for NR in 3GPP Release 17. The purpose of the application layer measurements is to measure the end user experience when using certain applications. Currently, QoE measurements for streaming services and for Mobility Telephony Service for Internet Protocol Multimedia Subsystem (MTSI) services are supported. For NR, virtual reality (VR) will likely be added to the list of services for which QoE measurements are specified and supported.

The solutions in LTE and UMTS are similar and share the following overall principles. Quality of Experience Measurement Collection (QMC) enables configuration of application layer measurements in the user equipment (UE) and transmission of QoE measurement result files (commonly referred to as QoE reports) to the network using radio resource control (RRC) signalling. An application layer measurement configuration (also referred to as QoE measurement configuration or QoE configuration) that the radio access network (RAN) receives from the operation and management (OAM) system or the core network (CN) is encapsulated in a transparent container, which is forwarded to a UE in a downlink RRC message. An application layer measurement report (also referred to as QoE report) that the UE access stratum (UE AS) or UE RRC layer receives from the UE's higher layer (application layer) is encapsulated in a transparent container and sent to the network in an uplink RRC message. The RAN then forwards the QoE report to a measurement collector entity (MCE).

In 3GPP release 17 a new study item for “Study on NR QoE management and optimizations for diverse services” for NR has been approved and concluded. The specification work for 3GPP release 17 is still ongoing. The purpose of the study item is to study solutions for QoE measurements in NR. QoE management in NR will not just collect the quality of experience parameters of streaming services but also consider the typical performance requirements of diverse services (e.g., augmented reality (AR)/VR and ultra-reliable low-latency communication (URLLC), of which at least VR appears to be covered in 3GPP release 17). Based on requirements of services, the NR study also included more adaptive QoE management schemes that enable network optimization to satisfy user experience for diverse services.

The configuration data related to QoE measurements (in standard specifications typically referred to as application layer measurements) consists of a service type indication, an indication of an area in which the measurements are to be performed (denoted area scope), an Internet Protocol (IP) address of the entity the collected measurement results (i.e., the QoE reports) should be sent to (often referred to as a MCE, Measurement Collector Entity or Measurement Collection Entity, but the entity may sometimes also be referred to as a Trace Collection Entity) and a set of instructions of which type of measurements that should be performed and details of how these measurements are to be performed. These instructions are intended for the application layer in the UE and are placed in a “container” that the network entities handling it, e.g. forwarding it to the UE, as well as the UE access stratum, cannot interpret and do not try to read. The currently specified service types are MTSI and streaming service (DASH), and in 3GPP release 17, at least service type VR will be added.

An area scope is defined in terms of cells or network related areas. In UMTS, an area scope is defined as either a list of cells, a list of routing areas or a list of tracking areas. In LTE, an area scope is defined as either a list of cells or a list of tracking areas. In NR, an area scope will be defined as either a list of cells or a list of tracking areas.

QoE, and in particular QoE configuration, comes in two flavors: management-based QoE configuration and signaling-based QoE configuration. In both cases the QoE configuration originates in the OAM system or some other administrational entity, e.g., dealing with customer satisfaction. All of these entities are herein referred to as the OAM system (where the OAM system also contains further entities).

With management-based QoE (m-based QoE), the OAM system is typically interested in general QoE statistics from a certain area (which is configured as an area scope). The m-based QoE configuration is sent directly from the OAM system to the RAN nodes controlling cells that are within the area scope. Each RAN node then selects UEs that are within the area scope (and also fulfills any other relevant condition, such as supporting the concerned application/service type) and sends the m-based QoE configuration to these UEs.

With signaling-based QoE (s-based QoE), the OAM system is interested in collecting QoE measurement results from a specific UE, e.g., because the user of the UE has filed a complaint. The OAM system sends the s-based QoE configuration to the home subscriber server (HSS) (in Evolved Packet System (EPS)/LTE) or unified data management (UDM) (in 5GS/NR), which forwards the QoE configuration to the UE's current core network (CN) node, e.g., a mobility management entity (MME) in EPS/LTE or an access and mobility management function (AMF) in 5G/NR. The CN then forwards the s-based QoE configuration to the RAN node that serves the concerned UE and the RAN forwards it to the UE.

Forwarded to the UE are the service type indication and the container with the measurement instructions. The UE is not aware of whether a received QoE configuration is m-based or s-based. In legacy systems, the QoE framework is integrated with the Trace functionality and a Trace ID is associated with each QoE configuration. In NR, the QoE functionality will be logically separated from the Trace functionality, but it will still partly reuse the Trace signaling mechanisms.

In NR and LTE, a globally unique QoE reference (formed of mobility country code (MCC)+mobile network code (MNC)+QoE measurement collection (QMC) identifier (ID), where the QMC ID is a string of 24 bits) will be associated with each QoE configuration. The QoE reference is included in the container with measurement instructions and also sent to the RAN (i.e., the gNB in NR). For the communication between the gNB and the UE, the QoE reference is replaced by a shorter identifier denoted as measConfigAppLayerId, which is locally unique within a UE (i.e., there is a one-to-one mapping between a measConfigAppLayerId and a QoE reference for each QoE configuration provided to a UE. The measConfigAppLayerId is stored in the UE access stratum and also forwarded in an Attention (AT) Command (which is the type of instructions used in the communication between the UE's modem part and the UE's application layer) together with the service type indication and the container with the measurement instructions.

Reports with collected QoE measurement results (QoE reports) are sent from the UE application layer to the UE access stratum, which forwards them to the RAN, which forwards them to the MCE. These QoE measurement results are placed in a “container”, which is uninterpretable for the UE access stratum and the RAN. QoE reporting can be configured to be periodic or only sent at the end of an application session. Furthermore, the RAN can instruct the UE to pause QoE reporting, e.g., if the cell/gNB is in a state of overload.

The RAN is not aware of when an application session with an associated QoE measurement session is ongoing and the UE access stratum is also not automatically aware of this. To alleviate this session start/stop indications can be introduced, which will be sent from the application layer in the UE to the UE access stratum and from the UE access stratum to the RAN. A session stop indication may be implicit in the form of a QoE report sent when the application session and the associated QoE measurement session are concluded.

The RAN may decide to release a QoE configuration in a UE at any time, as an implementation-based decision. Typically, it is done when the UE has moved outside an area configured for the QoE measurements, commonly referred to as the area scope.

One opportunity provided by legacy solutions is also to be able to keep the QoE measurement for the whole session, even during a handover situation. It is also discussed to let the UE continue with the QoE measurements on an ongoing application session until the application session ends, even if the UE in the meantime moves out of the configured area scope.

An extension of the QoE framework, which has been studied for 3GPP release 17 and which is currently being specified in 3GPP is the concept of RAN visible QoE (RVQoE). The regular QoE reports are intended for the MCE, which is an entity outside the RAN, e.g., a part of the OAM system, and the RAN cannot read the QoE reports (at least not according to specification, although gNB/eNB implementations are not prevented from doing so). In contrast, reported RVQoE metrics are intended for the RAN and are delivered to the RAN in a format that the RAN understands. The RVQoE metrics are derived from the regular QoE metrics, collected and compiled in reports by the UE application layer and delivered to the RAN, so that the RAN may use the reports for various types of optimizations. As an example, when the RAN receives RVQoE reports during an ongoing application session, the RAN can perform adaptive actions to impact the QoE of the concerned application session while the application session is ongoing, such as change various parameters related to the scheduling of the UE and the data flows related to the application session.

The following describes QoE configuration, measurement, and reporting in more detail.

FIG. 1 is a signaling diagram illustrating the basic signaling (without showing all details) involved in QoE measurement configuration, from the O&M system to the UE. FIG. 1 is reproduced from 3GPP TS 28.405 v16.0.0 “FIG. 4.2.1-1: QMC activation and reporting in LTE.”

When initiated via the core network, the measurement is started towards a specific UE. For the LTE case, the “TRACE START” S1AP message is used, which carries, among others, the details about the measurement configuration the application should collect (in the “Container for application layer measurement configuration” IE, transparent to the RAN) and the details to reach the trace collection entity to which the measurements should be sent.

Notifications of started and stopped application sessions with associated QoE measurement configurations are introduced, where these notifications are conveyed from the application layer in the UE and to the UE access stratum (i.e., the radio layers in the UE) and then forwarded to the network. This enables the network (at least the RAN) to be aware of when QoE measurements on an application session are ongoing. It is an implementation decision when the RAN stops the measurements. Typically, it is done when the UE has moved outside the configured area for measurement (also referred to as the area scope). However, this strategy is questioned by the desire to have QoE data that represent complete application sessions.

One opportunity provided by legacy solutions is also to be able to keep the QoE measurement for the whole application session, even during handover situation, so that reported QoE measurement data cover complete application sessions.

FIG. 2 is a signaling diagram illustrating configuration and reporting of QoE measurements using RRC signaling. The QoE measurements are configured in the UE by RRC signaling. The configuration is done using the RRC message RRCReconfiguration containing the IE appLayerMeasConfig. The UE starts collecting QoE measurements when the session starts in the application layer and when a report is ready, the report is sent to the network in the RRC message MeasurementReportAppLayer. The same RRC messages are used for both regular QoE and RVQoE.

AT commands are used for communication between the access stratum (radio) layer and the application layer in the UE. The AT commands are defined in 3GPP TS 27.007 version 17.6.0. The AT commands are used in QoE for transferring the configuration from the RRC layer to the application layer and for transferring reports from the application layer to the RRC layer.

In 5G/NR, a UE may be in either of three different RRC states: RRC_CONNECTED state, RRC_INACTIVE state and RRC_IDLE state. RRC_CONNECTED state is the state normally used when the UE is actively communicating. RRC_INACTIVE state and RRC_IDLE states are designed to allow the UE to save energy compared to when the UE is in RRC_CONNECTED state.

RRC_IDLE state is the state in which the UE consumes the least energy, When the UE is transferred to RRC_IDLE both the UE and the gNB delete the information related to the UE, i.e. the UE context, and the gNB thereby saves resources, but it comes at the cost of comparatively long network access time (e.g., transition to RRC_CONNECTED state).

RRC_INACTIVE state has properties that puts it in between the RRC_CONNECTED state and RRC_IDLE state. The purpose of the RRC_INACTIVE state is to reduce the signaling overhead over the radio and network interface and to improve the UE access latency (compared to RRC_IDLE state) as well as the UE energy consumption. In this state, the core network still regards the UE as connected, thus the CN-RAN connection for the UE is kept active although the RRC connection between the gNB and the UE is suspended. The gNB that maintains the connection to the CN while the UE is in RRC_INACTIVE state is referred to as the anchor gNB.

To reduce radio interface signaling at connection establishment, the UE context information is kept in the UE and in the anchor gNB, which enables the UE to resume its RRC connection when it is paged or has uplink data or signaling to send. When the CN has user data or control data to send to the UE, the data is sent to the anchor gNB, which then initiates paging of the UE (i.e., RAN initiated paging).

When the UE initially connects to the network the UE starts by searching for a cell to camp on in idle mode, referred to as initial cell selection. If the UE has previously been connected to the network and has a cell stored, the UE performs a cell selection procedure. As long as the UE resides in RRC_IDLE or RRC_INACTIVE it continuously monitors which cell is the best and may change cell if another cell becomes better, i.e. perform cell reselection. The procedures in RRC_IDLE and RRC_INACTIVE are described in 3GPP TS 38.304 version 17.1.0, User Equipment (UE) procedures in Idle mode and RRC Inactive state.

Unlike procedures in RRC_CONNECTED, where the control is mainly on the network side, the procedures in RRC_IDLE and RRC_INACTIVE are to a larger extent handled in the UE according to TS 38.304. A mobility procedure in RRC_IDLE and RRC_INACTIVE is the cell reselection procedure, and handover is an example of mobility procedure in RRC_CONNECTED.

FIG. 3, reproduced from 3GPP TS 38.403 version 17.1.0, is a flowchart illustrating a UE selecting a suitable cell on which to camp. FIG. 3 shows the states and state transitions and procedures in RRC_IDLE and RRC_INACTIVE. Whenever a new public land mobile network (PLMN) selection or new standalone non-public network (SNPN) selection is performed, it causes an exit to step number 1.

Multicast and broadcast service (MBS) is a point-to-multipoint service in which services and data are transmitted from a single source entity to multiple recipients, either to all UEs in a Broadcast service area, or to users in a multicast group as defined in 3GPP TS 23.247.

5G NR system enables delivery of MBS in a resource-efficient way. Via the MBS, the same service and the same specific content data from a single source can be provided simultaneously to all UEs in a geographical area (in the broadcast communication service) or to a dedicated set of UEs (in the multicast communication service). That is, all UEs in a broadcast area can receive the data, while not all UEs are authorized to receive the data in a multicast area.

A UE can receive a broadcast MBS communication service independently of its RRC state, while a multicast MBS service can be received only by the UEs in the RRC_CONNECTED state. Multicast communication data can be delivered to a UE via Point-to-Point (PTP) and/or Point-To-Multipoint (PTM) mechanisms, and hybrid automatic repeat request (HARQ) retransmission/feedback can be applied to both of these mechanisms, as specified in 3GPP TS 38.300. An example is illustrated in FIG. 4.

FIG. 4 illustrates an example of MBS delivery methods, as shown in 3GPP TS 23.247.

For a multicast communication service, shared and individual delivery modes are specified in 3GPP TS 23.247. Between 5GC and NG-RAN, there are two possible delivery methods to transmit the MBS data. One method is the 5GC individual MBS traffic delivery method: This method is only applied for multicast MBS sessions. The 5GC receives a single copy of MBS data packets and delivers separate copies of those MBS data packets to individual UEs via per-UE protocol data unit (PDU) sessions. Thus, for each such UE one PDU session is required to be associated with a multicast MBS session. The MBS data received by the MB-user plane function (UPF) is replicated towards the UPF(s) where individual delivery is performed via unicast transport over N19mb interface.

The other method is the 5GC shared MBS traffic delivery method: This method is applied for both broadcast and multicast MBS sessions. The 5GC receives a single copy of MBS data packets and delivers a single copy of those MBS packets to an NG-RAN node, which then delivers the packets to one or multiple UEs. The incoming MBS traffic packets are delivered from MB-UPF to NG-RAN node via the N3mb interface.

The 5GC shared MBS traffic delivery method is required in all MBS deployments. The 5GC individual MBS traffic delivery method is required to enable mobility when there is an NG-RAN deployment with non-homogeneous support of MBS.

Between the NG-RAN and the UE, two delivery methods are available for the transmission of MBS data packets over radio interface. One is the point-to-point (PTP) delivery method, where the NG-RAN delivers separate copies of MBS data packets over the radio interface to individual UE(s). The other is the point-to-multipoint (PTM) delivery method, where the NG-RAN delivers a single copy of MBS data packets over the radio interface to multiple UEs. The NG-RAN may use a combination of PTP/PTM to deliver MBS data packets to UEs.

An MBS session resource may be associated with one or more MBS QOS flows, and each of those flows is associated with a QoS profile. A gNB provides one or more multicast MBS radio bearer (MRB) configurations to the UE via RRC signaling, as described in TS 38.300, clause 16.10.3. For a multicast session, the gNB may change the MRB type using RRC signaling. For a broadcast session, the gNB provides a broadcast MRB with one downlink-only RLC-UM entity for PTM transmission, i.e. only one type of an MRB is specified at the moment for the broadcast communication transmission. Network and protocol architectures are described in detail in 3GPP TS 38.300 chapters 16.10.2 and 16.10.3.

Group scheduling mechanisms for MBS delivery are described in 3GPP TS 38.300, clause 16.10.4. A radio network temporary identifier (RNTI) is used for the group transmission where a UE can receive different services using the same or different G-RNTI(s)/G-CS-RNTIs, as defined in 3GPP TS 38.300.

The NG-RAN performs certain functions to support MBS. They include management of MBS QoS flows, delivery of MBS data packets from 5GC to multiple UEs via PTP or PTM, configuration of UE for MBS QoS flow reception at access stratum layer, controlling switching between PTM and PTP delivery per UE, support for multicast session service continuity during Xn and NG handovers, and support for group paging at multicast session activation over radio toward UEs in CM-IDLE state and CM-CONNECTED with RRC INACTIVE state.

To ensure service continuity of MBS broadcast, the UE in RRC_CONNECTED state may send a MBS interest indication to the gNB, consisting of the following information: (a) list of MBS frequencies the UE is interested in receiving, sorted in decreasing order of interest; (b) priority between the reception of all listed MBS frequencies and the reception of any unicast bearer; (c) list of MBS broadcast services the UE is interested in receiving, if SIB20 is scheduled by the UE's PCell; and/or (d) UE's priority to MBS broadcast versus unicast reception.

MBS interest indication information reporting can be implicitly enabled/disabled by the presence of SIB21.

Mobility support for service continuation when a UE is in an MBS session depends on whether the broadcast or multicast session is taking place, and on whether the source and target nodes support MBS. For the multicast MBS session, three cases can be distinguished: 1) handover from an NG-RAN node supporting MBS to a node not supporting MBS, 2) handover from an NG-RAN node not supporting MBS to a node supporting MBS, and 3) a handover from a node supporting MBS to another node supporting MBS.

For multicast MBS, when the handover takes place from a node that supports MBS to a node that does not support MBS, or vice versa, the 5GC shared MBS traffic delivery and 5GC individual traffic delivery methods can co-exist temporarily upon handover.

Mapping information about unicast QoS flows for multicast data transmission and the information of associated multicast QoS flows are provided to an NG-RAN node.

The delivery method is switched from 5GC shared MBS traffic delivery to 5GC individual MBS delivery via establishing the N3 tunnel of the PDU session for individual delivery. The session management function (SMF) realizes that the target node does not support MBS.

A general packet radio service tunneling protocol (GTP) tunnel between the UPF and the MB-UPF for 5GC individual MBS traffic delivery is activated by SMF and MBS-SMF.

When the handover takes place from a RAN node that supports MBS to another node that also supports MBS, if the shared delivery for the MBS session has not been established towards the target NG-RAN node, it uses MB-SMF (Multicast Broadcast Session Management Function) and MB-UPF (Multicast Broadcast User Place Function) to establish the shared delivery for the MBS session.

The PDU sessions, including the one associated with the MBS multicast session and used for the 5GC individual MBS traffic delivery, are handed over to the target NG-RAN node.

The SMF triggers the mode switch from the individual to the shared delivery mode. The target node establishes the shared delivery for the MBS session upon receiving the MBS session context.

5GC individual MBS traffic delivery is terminated by 5GC and changed to the 5GC shared MBS traffic delivery.

For broadcast MBS, the UE may receive the same service in the target node (which supports MBS) if the same MBS session is established with the 5GC shared MBS traffic delivery. Currently, the scenario where a UE is handed over to a node not supporting the MBS within the broadcast area is not specified.

There currently exist certain challenges. For example, in 3GPP Release 17, the QoE measurements are done when the UE is in RRC_CONNECTED state. In the 3GPP release 18 work item for QoE, the UE will be able to perform QoE measurements also when in RRC_INACTIVE and RRC_IDLE, including performing QoE measurements when MBS is used. In existing specifications, there is no support for QoE measurements in RRC_INACTIVE and RRC_IDLE state. Previously proposed solutions described how to maintain the measurement continuity while the UE is in RRC_IDLE and RRC_INACTIVE states, but they do not describe how to maintain this continuity upon UE mobility.

### SUMMARY

As described above, certain challenges currently exist with mobility support for quality of experience (QoE) reporting. Certain aspects of the present disclosure and their embodiments may provide solutions to these or other challenges. For example, particular embodiments support mobility when QoE measurements are configured to be performed in RRC_INACTIVE and RRC_IDLE states.

Particular embodiments support QoE for multicast and broadcast service (MBS) in conjunction with mobility. In one scenario, a user equipment (UE) that is configured with QoE measurements for MBS moves between cells in RRC_INACTIVE or RRC_IDLE state (i.e., moving between cells by means of cell re-selection). In particular embodiments, a UE sends QoE and/or radio access network (RAN) visible QoE (RVQoE) measurement reports after re-selecting to another cell than the cell in which it received the concerned QoE and/or RVQoE configuration. Such support may, e.g., include broadcast in the system information of indications of support for such reporting and/or instructions for such reporting. In addition, support in the form of inter-node signaling in the network may be provided, e.g., to provide a RAN node receiving a QoE and/or RVQoE report from the UE with the necessary information to be able to process the received report, e.g., to forward a QoE report to the correct measurement collector entity (MCE).

For mobility related to non-RRC_CONNECTED states, particular embodiments comprise a method executed by a UE. The method comprises reading a system information broadcast. The system information broadcast may contain one or more of the following:
An indication that the gNB supports QoE measurement configuration and/or reporting. As an option, the UE may derive this from an explicit or implicit indication that the cell and/or gNB supports the QoE framework.
An indication that the gNB supports RVQoE measurement configuration and/or reporting. As an option, the UE can derive this from an explicit or implicit indication that the cell and/or gNB supports the RVQoE framework.
An indication that the gNB supports configuration and/or reporting of QoE related events. As an option, the UE can derive this from an explicit or implicit indication that the cell and/or gNB supports the QoE framework.
Parameters related to QoE/RVQoE measurements for MBS, e.g., an MBS Service Area, MBS Session ID, temporary mobile group identity (TMGI), MBS Frequency Selection Area ID.
Indications related to allowed-lists and not-allowed-lists (list of barred cells) for transmission of QoE reports.
An indication that the UE shall request to be resumed to RRC_CONNECTED only for the reason to transmit QoE reports, even if there is no other reason to resume to RRC_CONNECTED.
An indication that a UE in RRC_INACTIVE may request to use small data transmission for transmitting QoE/RVQoE reports.
An indication that a UE in RRC_INACTIVE may be requested (e.g., via paging or RAN paging) to use small data transmission for transmitting QoE/RVQoE reports.

Further indications are described in more detail below.

The method further comprises receiving a message instructing the UE to transition from RRC_CONNECTED to RRC_INACTIVE (e.g., an RRCRelease message) comprising (e.g., as part of a SuspendConfig IE), one or more of the information as indicated above for the system information broadcast.

The method further comprises performing cell reselection. If there are multiple suitable cells, and the UE is configured with QoE measurements in RRC_IDLE/RRC_INACTIVE state, the UE may choose a cell that supports reception of QoE reports.

As one option, when returning to RRC_CONNECTED state from RRC_IDLE state, and optionally also when resuming to RRC_CONNECTED state from RRC_INACTIVE state, the method may comprise transmitting, e.g. in an RRCResumeComplete message or an RRCSetupComplete message: an indication that the UE has QoE related information to transmit to the network, e.g. MCE address, MCE Identifier, QoE configuration parameters, QoE related events, one or more QoE measurement report(s), and/or an indication that the UE has RVQoE related information to transmit to the network, e.g. RVQoE configuration parameters, RVQoE related events, one or more RVQoE measurement report(s).

For mobility related to non-RRC_CONNECTED states, particular embodiments include a method executed by a network node, e.g. a gNB. The method comprises transmitting a system information broadcast, wherein the system information broadcast may contain one or multiple of the following:
An indication that the gNB supports QoE measurement reporting.
An indication that the gNB supports RVQoE measurement configuration and/or reporting.
An indication that the gNB supports configuration and/or reporting of QoE related events.
Parameters related to QoE/RVQoE measurements for MBS, e.g., an MBS Service Area, MBS Session ID, TMGI, MBS Frequency Selection Area ID.
Indications related to allowed-lists and not-allowed-lists (list of barred cells) for transmission of QoE reports.
An indication that the UE shall request to be resumed to RRC_CONNECTED only for the reason to transmit QoE reports, even if there is no other reason to resume to RRC_CONNECTED.

Optionally, the method may comprise receiving from a UE a request to transit to RRC_CONNECTED state.

Optionally, the method may comprise receiving from the UE when returning to RRC_CONNECTED, e.g. in an RRCResumeComplete message or an RRCSetupComplete message: an indication that the UE has QoE related information to transmit to the network, e.g. MCE address, MCE Identifier, QoE configuration parameters, QoE related event, QoE report(s). Optionally, the indication concerns only pending QoE report(s) (whereas the network node can obtain the other QoE related information in other ways, as described in more detail below).

Some embodiments include methods related to mobility in RRC_CONNECTED state.

In general, particular embodiments support mobility when the UE is configured to perform QoE/RVQoE measurements and when the communication service or service type is MBS. The focus is on mobility in RRC_IDLE and RRC_INACTIVE, but also includes options related to mobility when performing the measurements in RRC_CONNECTED state.

According to some embodiments, a method is performed by a wireless device comprising: obtaining a QoE configuration for QoE operations with respect to a MBS in a first cell of a first network node; transitioning to an idle or inactive state; performing cell reselection to a second cell of a second network node; obtaining an indication that the second cell supports QoE operations; transitioning to a connected state; and transmitting a QoE report to the second network node in the second cell.

In particular embodiments, the method further comprises transmitting an indication of the QoE configuration to the network node in the second cell.

In particular embodiments, the method further comprises transmitting an indication to the network node in the second cell that the wireless device has a QoE report available. Transmitting the indication to the network node in the second cell that the wireless device has a QE report available may be based on a cause value for transitioning to the connected state. Transmitting the indication to the network node in the second cell that the wireless device has a QoE report available may comprise transmitting a small data transmission (SDT).

In particular embodiments, the method further comprises receiving a request from the second network node for a QoE report.

In particular embodiments, the QoE configuration comprises a RVQoE configuration.

In particular embodiments, obtaining the indication that the second cell supports QoE operations comprises receiving system information from the network node in the second cell. The indication that the second cell supports QoE operations may comprise any one or more of the following: an indication that the second cell supports one or more of QoE/RVQoE configuration, QoE/RVQoE measurement, and QoE/RVQoE reporting, an indication that the second cell supports signaling radio bearer four (SRB4); and/or an indication that the wireless device may use SDT for transmitting QoE/RVQoE reports.

According to some embodiments, a wireless device comprises processing circuitry operable to perform any of the methods of the wireless receiver described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method is performed by a network node comprising: transmitting an indication that the network node supports QoE operation with respect to a MBS to a wireless device; transitioning the wireless device to a connected state; and receiving a QoE report from the wireless device, wherein the wireless device was configured for QoE operation and transitioned to an inactive or idle state before performing a reselection to the network node.

In particular embodiments, the method further comprises receiving an indication of a QoE configuration of the wireless device.

In particular embodiments, the method further comprises receiving an indication that the wireless device has a QoE report available. Receiving the indication that the wireless device has a QoE report available may be based on a cause value for transitioning to the connected state. Receiving the indication that the wireless device has a QoE report available may comprise receiving a small data transmission, SDT.

In particular embodiments, the method further comprises transmitting a request to the wireless device for a QoE report.

In particular embodiments, the QoE operation comprises a RVQoE operation.

In particular embodiments, transmitting the indication that the second cell supports QoE operations comprising transmitting system information. The indication that the network node supports QoE operations may comprise any one or more of the following: an indication that the second cell supports one or more of QoE/RVQoE configuration, QoE/RVQoE measurement, and QoE/RVQoE reporting; an indication that the second cell supports SRB4; and an indication that the wireless device may use SDT for transmitting QoE/RVQoE reports.

According to some embodiments, a network node comprises processing circuitry operable to perform any of the methods of the network node described above.

Also disclosed is a computer program product comprising a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments provide solutions for mobility of a UE while in RRC_IDLE and RRC_INACTIVE when the UE is configured with QoE measurements. Particular embodiments make the UE behavior and the transmission of QoE measurement reports controlled and predictable if the UE changes cell while in RRC_IDLE and RRC_INACTIVE.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a signaling diagram illustrating the basic signaling involved in quality of experience (QoE) measurement configuration, from the operations and management (O&M) system to the user equipment (UE);

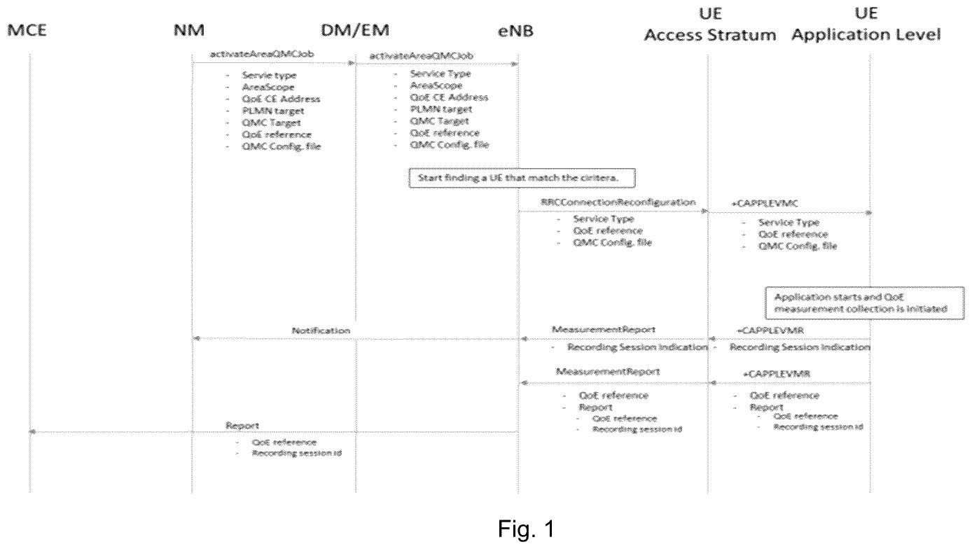

FIG. 2 is a signaling diagram illustrating configuration and reporting of QoE measurements using Radio Resource Control (RRC) signaling;

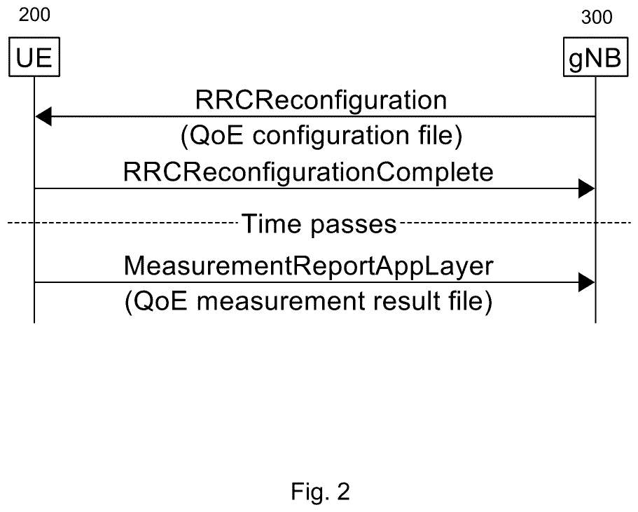

FIG. 3 is a flowchart illustrating a UE selecting a suitable cell on which to camp;

FIG. 4 illustrates an example of multicast and broadcast service (MBS) delivery methods;

FIG. 5 is a network diagram illustrating cell reselection for a UE configured with QoE measurements in RRC_IDLE/RRC_INACTIVE;

FIG. 6 illustrates an example communication system, according to certain embodiments;

FIG. 7 illustrates an example user equipment (UE), according to certain embodiments;

FIG. 8 illustrates an example network node, according to certain embodiments;

FIG. 9 illustrates a block diagram of a host, according to certain embodiments;

FIG. 10 illustrates a virtualization environment in which functions implemented by some embodiments may be virtualized, according to certain embodiments;

FIG. 11 illustrates a host communicating via a network node with a UE over a partially wireless connection, according to certain embodiments;

FIG. 12 illustrates a method performed by a wireless device, according to certain embodiments; and

FIG. 13 illustrates a method performed by a network node, according to certain embodiments.

### DETAILED DESCRIPTION

As described above, certain challenges currently exist with mobility support for quality of experience (QoE) reporting. Certain aspects of the present disclosure and their embodiments may provide solutions to these or other challenges. For example, particular embodiments support mobility when QoE measurements are configured to be performed in RRC_INACTIVE and RRC IDLE states.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

The terms “user equipment (UE),” “terminal equipment” and “wireless terminal” are used interchangeably. The terms “network node” and “radio access network (RAN) node” are used interchangeably, where the RAN node may be a gNB, eNB, gNB-CU, gNB-CU-CP, eNB-CU, eNB-CU-CP, integrated access and backhaul (IAB)-donor, IAB-donor-CU, IAB-donor-CU-CP.

The terms measurement collector entity (MCE) and trace collection entity (TCE) are used interchangeably. The terms “application layer measurement configuration,” “application measurement configuration,” “QoE measurement configuration,” “QoE information,” “QoE configuration” and “QoE measurement and reporting configuration” are used interchangeably.

The terms “modem,” “radio layer,” “access stratum (AS) layer,” “Radio Resource Control (RRC) layer” and “radio network layer” are used interchangeably. The terms “access stratum” and “radio layer” are used interchangeably.

The terms “service subtype” and “subservice type” area used interchangeably.

The term “session” may refer to either a QoE measurement session or an application session or an application session for which QoE measurements are applied.

Particular embodiments apply to universal mobile telecommunications service (UMTS), long term evolution (LTE) and new radio (NR) as well as future radio access technologies (RATs) such as sixth generation (6G).

All references to the application layer are with respect to the application layer of the UE. RAN nodes do not have an application layer.

Particular embodiments apply to both signaling-and management-based QoE measurements. Particular embodiments apply to both QoE and RAN visible QoE (RVQoE).

Particular embodiments are primarily described in 5G/NR terms, implying application of the solution in 5G/NR, but the embodiments are also applicable in LTE (in which case for example a gNB may be replaced by an eNB, and an RRCReconfiguration message may be replaced by an RRCConnectionReconfiguration message).

The application layer described with respect to particular embodiments may instead be some other higher layer in the UE or the QoE coordinator entity.

The embodiments are described with respect to a single UE, but the actions therein may equally apply to more than UE simultaneously.

The terms “radio network node” and “RN node” are used interchangeably.

The term “application layer capability” may refer to one or more of the following (non-limiting examples): support or subscription for running an application, and/or certain applications downloaded in the UE.

Particular embodiments support QoE for multicast and broadcast service (MBS) in conjunction with mobility. In one scenario, a UE that is configured with QoE measurements for MBS moves between cells in RRC_INACTIVE or RRC_IDLE state (i.e., moving between cells by means of cell re-selection).

In particular embodiments, a UE sends QoE and/or RVQoE measurement reports after re-selecting to another cell than the cell in which the UE received the concerned QoE and/or RVQoE configuration. Such support may, e.g., include broadcast in the system information of indications of support for such reporting and/or instructions for such reporting.

In addition, support in the form of inter-node signaling in the network may be provided, e.g., to provide a RAN node receiving a QoE and/or RVQoE report from the UE with the necessary information to be able to process the received report, e.g., to forward a QoE report to the correct MCE.

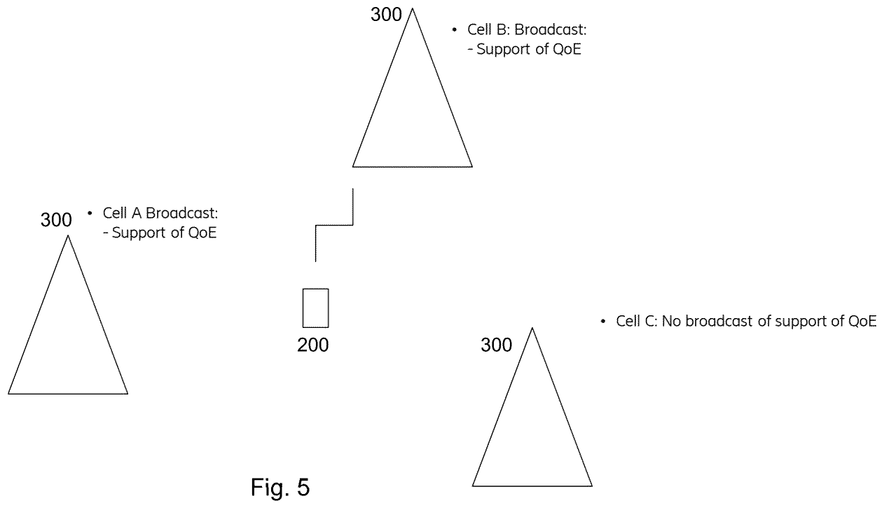

FIG. 5 is a network diagram illustrating cell reselection for a UE configured with QoE measurements in RRC_IDLE/_RRC_INACTIVE (i.e., non-RRC Connected state). In the illustrated example, Cells A and B support QoE and Cell C does not support QoE.

In an example scenario, while in RRC_CONNECTED state, the UE has been configured with QoE measurements and has thereafter been transferred from RRC_CONNECTED to RRC_IDLE or RRC_INACTIVE.

QoE measurements may continue in the non-RRC CONNECTED state, if indicated so, if a UE continues receiving the MBS session after moving to another gNB supporting MBS and QoE measurements.

Particular embodiments include a method executed by a UE. The method comprises, optionally, sending to the gNB a request for on demand system information, for requesting to receive one or more indications/parameters as described below for system information broadcast. This option is used if the SI message containing the concerned information is indicated (in SIB1) as available on demand.

The method comprises reading system information broadcast, wherein the system information broadcast may contain one or more of the following:
An indication that the gNB supports QoE measurements, an indication that the gNB supports QoE measurement reporting, an indication that the gNB supports SRB4 or another indication indicating that the UE may transmit QoE measurement reports to the gNB.
An indication that the gNB support/not support QoE/RVQoE configuration to be used by UE in RRC_IDLE/RRC_INACTIVE. As an option, the UE may derive this from an explicit or implicit indication that the cell and/or gNB supports the QoE/RVQoE framework.
An indication indicating that any QoE/RVQoE configuration that the UE has may be kept at the UE or (on the contrary) shall be released.
An indication that the gNB supports RVQoE measurement configuration and/or reporting. As an option, the UE may derive this from an explicit or implicit indication that the cell and/or gNB supports the QoE framework.
An indication that the gNB supports configuration and/or reporting of QoE related events. As an option, the UE can derive this from an explicit or implicit indication that the cell and/or gNB supports the QoE framework.
An indication that the gNB supports QoE measurement reporting (i.e., reception of a QoE measurement report from a UE and forwarding it to the intended receiver) when the QoE report is related to a QoE configuration the UE received in another cell, and the UE has been in RRC_INACTIVE state at least at one point in time after it received the QoE configuration. As an option, the UE can derive this from an explicit or implicit indication that the cell and/or gNB supports the QoE framework.
An indication that the gNB supports QoE measurement reporting (i.e., reception of a QoE measurement report from a UE and forwarding it to the intended receiver) when the QoE report is related to a QoE configuration the UE received in another cell which is controlled by another gNB, and the UE has been in RRC_INACTIVE state at least at one point in time after it received the QoE configuration. As an option, the UE can derive this from an explicit or implicit indication that the cell and/or gNB supports the QoE framework.
An indication that the gNB supports QoE measurement reporting (i.e., reception of a QoE measurement report from a UE and forwarding it to the intended receiver) when the UE has been in RRC_IDLE state at least at one point in time after it received the QoE configuration. As an option, the UE can derive this from an explicit or implicit indication that the cell and/or gNB supports the QoE framework.
An indication that the gNB supports RVQoE measurement reporting (i.e., reception of a RVQoE measurement report from a UE) when the RVQoE report is related to a RVQoE configuration the UE received in another cell, and the UE has been in RRC_INACTIVE state at least at one point in time after it received the RVQoE configuration. As an option, the UE can derive this from an explicit or implicit indication that the cell and/or gNB supports the RVQoE framework.
An indication that the gNB supports RVQoE measurement reporting (i.e., reception of a RVQoE measurement report from a UE) when the RVQoE report is related to a RVQoE configuration the UE received in another cell which is controlled by another gNB, and the UE has been in RRC_INACTIVE state at least at one point in time after it received the RVQoE configuration. As an option, the UE can derive this from an explicit or implicit indication that the cell and/or gNB supports the RVQoE framework.
An indication that the gNB supports RVQoE measurement reporting (i.e., reception of a RVQoE measurement report from a UE) when the UE has been in RRC_IDLE state at least at one point in time after it received the RVQoE configuration. As an option, the UE can derive this from an explicit or implicit indication that the cell and/or gNB supports the RVQoE framework.
Parameters related to QoE/RVQoE measurements for MBS, e.g. an MBS Service Area, MBS Session ID, TMGI, MBS Frequency Selection Area ID.
Indications related to allowed-lists and not-allowed-lists (list of barred cells) for transmission of QoE reports. For example, cells, to which the UE may transmit QoE reports to, transmit an indication that the UE may transmit QoE reports to this cell. Alternatively, or additionally, cells which the UE may not transmit QoE reports to, transmit an indication that the UE may not transmit QoE report to this cell, i.e. the UE is barred from transmitting QoE reports to the cell.

An indication that the UE shall request to be resumed to RRC_CONNECTED only for the reason to transmit QoE reports, even if there is no other reason to resume to RRC_CONNECTED. There may be one indication for regular QoE measurements and one indication for RAN visible QoE measurements.
An indication that the UE shall not request to be resumed to RRC_CONNECTED only for the reason to transmit QoE reports, i.e. the UE shall wait with transmitting QoE reports until it resumes to RRC_CONNECTED for some other reason. There may be one indication for regular QoE measurements and one indication for RAN visible QoE measurements.
An indication that a UE in RRC_INACTIVE may request to use small data transmission (SDT) for transmitting QoE/RVQoE reports.
An indication that a UE in RRC_INACTIVE may be requested (e.g., via paging or RAN paging) to use SDT for transmitting QoE/RVQoE reports.

The method further comprises performing cell reselection. If there are multiple suitable cells, and the UE is configured with QoE measurements in RRC_IDLE/RRC_INACTIVE the UE may choose a cell that supports reception of QoE reports. For example, as shown in FIG. 5, the UE may choose to reselect to cell B instead of cell C, when moving further away from cell A.

The UE may at cell reselection transmit information related to QoE to the network, e.g. MCE address(es), MCE identifier(s), QoE configuration parameters, QoE related event(s), QoE/RVQoE measurements. In one alternative, the UE only transmits the QoE related information if the network has indicated to the UE that it shall or may transmit the QoE related information. The network may, e.g., indicate this to the UE in dedicated RRC signaling or by broadcasting it in system information. In one variant, the UE transmits an indication (e.g., a flag) to indicate to the network that it has QoE related information ready to be transmitted.

In some embodiments, the method comprises initiation of the QoE measurements when a UE enters MBS session while in RRC INACTIVE state: If a UE is not in an MBS session before the mobility (cell reselection), QoE configuration may be kept when a UE is in RRC INACTIVE (because the UE context is kept, and therefore, information for mapping of the protocol data unit (PDU) session resource associated with the MBS session resource) with indications to start measurement upon reception of a service which is provided in RRC INACTIVE. The initial configuration with MBS related parameters is provided to a UE in a list of QoE configurations according to UEs capabilities and area scope, while the UE is in an RRC CONNECTED state, and configuration remains in the UE when the UE moves to RRC INACTIVE or IDLE state.)

In some embodiments, the method comprises initiation of the QoE measurements when a UE enters MBS session while in RRC IDLE state and there is mobility to a new cell. QoE configuration provided in RRC CONNECTED should contain indications to continue the application layer measurements in RRC IDLE.

When returning to RRC_CONNECTED, the method comprises transmitting, e.g. in an RRCResumeComplete message or an RRCSetupComplete message: an indication that the UE has QoE and/or RVQoE related information to transmit to the network, e.g., MCE address(es), MCE Identifier(s), QoE configuration parameters, RVQoE configuration parameters, QoE related event(s), RVQoE related event(s), QoE/RVQoE measurements report(s); and/or QoE and/or RVQoE related information, e.g. MCE address(es), MCE Identifier(s), QoE configuration parameters, RVQoE configuration parameters, QoE related event(s), RVQoE related event(s), QoE measurement report(s), RVQoE measurement report(s).

Optionally, e.g., after having indicated availability of QoE related information to transmit (as described in the option above), the method may comprise receiving a request from the gNB to send to the gNB QoE related information available in the UE.

Optionally, e.g. after having indicated availability of RVQoE related information to transmit (as described in the option above), the method may comprise receiving a request from the gNB to send to the gNB RVQoE related information available in the UE.

In one variant, the above indication and/or QoE/RVQoE related information may be sent from the UE only when the resume procedure is initiated for specific scenarios, corresponding to specific value(s) of the resume cause. For example, QoE/RVQoE related information may be sent only when the resume cause is set to “rna-Update”.

In another variant, the above indication and/or QoE/RVQoE related information may/should/shall not be sent from the UE when the resume procedure is initiated for specific scenario(s), corresponding to specific value(s) of the resume cause. For example, QoE/RVQoE related information should not be sent when the resume cause is set to “emergency” and/or “rna-Update.” When the resume cause is set to “emergency,” for example, the resume cause indicates the need to serve the UE with high priority, and this procedure should not be put at risk or delayed by transmission of QoE related data, considered as data of lower priority.

As another option, upon transiting to RRC_CONNECTED state and receiving (or having received) an indication that the gNB supports QoE measurement reporting when conditions match the UE's conditions (as described in various listed examples/options above, e.g., in terms of the RRC state the UE is transiting from and/or whether the related QoE configuration was received in another cell and/or from another gNB) the UE sends (e.g., in a MeasurementReportAppLayer RRC message) one or more QoE measurement report(s) pertaining to a QoE configuration received prior to the transition to RRC_CONNECTED state (e.g., received during a previous period in RRC_CONNECTED state), without first having indicated to the gNB the availability of the QoE report(s) in the UE.

As one option, the UE does this upon receiving a request or an indication from the gNB to do so (in which case another option for the message to use may be the UEInformationResponse RRC message, e.g., if the request or indication was received in a UEInformationRequest RRC message).

As another option, the UE does this without having received a request or an indication from the gNB to do so.

As another option, upon transiting to RRC_CONNECTED state and receiving (or having received) an indication that the gNB supports RVQoE measurement reporting when conditions match the UE's conditions (as described in various listed examples/options above, e.g., in terms of the RRC state the UE is transiting from and/or whether the related RVQoE configuration was received in another cell and/or from another gNB) the UE sends (e.g., in a MeasurementReportAppLayer RRC message) one or more RVQoE measurement report(s) pertaining to a RVQoE configuration received prior to the transition to RRC_CONNECTED state (e.g., received during a previous period in RRC_CONNECTED state), without first having indicated to the gNB the availability of the RVQoE report(s) in the UE.

As one option, the UE does this upon receiving a request or an indication from the gNB to do so (in which case another option for the message to use may be the UEInformationResponse RRC message, e.g., if the request or indication was received in a UEInformationRequest RRC message).

As another option, the UE does this without having received a request or an indication from the gNB to do so.

When performing SDT with/without UE context relocation, the method comprises transmitting, e.g., in an RRCResumeRequest message or an RRCResumeRequest1 message, as part of uplink SDT data and/or uplink SDT signaling: an indication that the UE has QoE related information to transmit to the network, e.g. MCE address, MCE Identifier, QoE and/or RVQoE configuration parameters, QoE related event(s), RVQoE related event(s), QoE measurement report(s), RVQoE measurement report(s); and/or QoE or RVQoE related information, e.g. MCE address, MCE Identifier, QoE and/or RVQoE configuration parameters, QoE related event(s), RVQoE related event(s), QoE measurement report(s), RVQoE measurement report(s).

The actions above are separate actions which may be performed separately, i.e. the UE may perform one or multiple of the actions.

Some embodiments include a method executed by a network node, e.g. a gNB. The method comprises, optionally, receiving from a UE a request for on demand system information, for requesting to receive one or more indications/parameters as described below for system information broadcast. This option is valid if the system information message containing the concerned information is indicated (in SIB1) as available on demand.

The method comprises transmitting system information broadcast, wherein the system information broadcast may contain one or multiple of the following:
An indication that the gNB supports QoE measurements, an indication that the gNB supports QoE measurement reporting, an indication that the gNB supports SRB4 or another indication indicating that the UE may transmit QoE measurement reports to the gNB. As an option, this indication may be a more generic indication from which the UE can derive the above described specific information, e.g., an indication in the form of an explicit or implicit indication that the cell and/or gNB supports the QoE framework.
An indication that the gNB supports RVQoE measurement configuration and/or reporting. As an option, this indication may be a more generic indication from which the UE can derive the above described specific information, e.g., an indication in the form of an explicit or implicit indication that the cell and/or gNB supports the RVQoE framework.
An indication that the gNB supports configuration of and/or receiving reports of QoE related event(s). As an option, this indication may be a more generic indication from which the UE can derive the above described specific information, e.g., an indication in the form of an explicit or implicit indication that the cell and/or gNB supports the QoE framework.
An indication that the gNB supports configuration of and/or receiving reports of RVQoE related event(s). As an option, this indication may be a more generic indication from which the UE can derive the above described specific information, e.g., an indication in the form of an explicit or implicit indication that the cell and/or gNB supports the RVQoE framework.
An indication that the gNB supports QoE measurement reporting (i.e., reception of a QoE measurement report from a UE and forwarding it to the intended receiver) when the QoE report is related to a QoE configuration the UE received in another cell, and the UE has been in RRC_INACTIVE state at least at one point in time after it received the QoE configuration. As an option, this indication may be a more generic indication from which the UE can derive the above described specific information, e.g., an indication in the form of an explicit or implicit indication that the cell and/or gNB supports the QoE framework.
An indication that the gNB supports QoE measurement reporting (i.e., reception of a QoE measurement report from a UE and forwarding it to the intended receiver) when the QoE report is related to a QoE configuration the UE received in another cell which is controlled by another gNB, and the UE has been in RRC_INACTIVE state at least at one point in time after it received the QoE configuration. As an option, this indication may be a more generic indication from which the UE can derive the above described specific information, e.g., an indication in the form of an explicit or implicit indication that the cell and/or gNB supports the QoE framework.
An indication that the gNB supports QoE measurement reporting (i.e., reception of a QoE measurement report from a UE and forwarding it to the intended receiver) when the UE has been in RRC_IDLE state at least at one point in time after it received the QoE configuration. As an option, this indication may be a more generic indication from which the UE can derive the above described specific information, e.g., an indication in the form of an explicit or implicit indication that the cell and/or gNB supports the QoE framework.
An indication that the gNB supports RVQoE measurement reporting (i.e., reception of a RVQoE measurement report from a UE) when the RVQoE report is related to a RVQoE configuration the UE received in another cell, and the UE has been in RRC_INACTIVE state at least at one point in time after it received the RVQoE configuration. As an option, this indication may be a more generic indication from which the UE can derive the above described specific information, e.g., an indication in the form of an explicit or implicit indication that the cell and/or gNB supports the RVQoE framework.
An indication that the gNB supports RVQoE measurement reporting (i.e., reception of a RVQoE measurement report from a UE) when the RVQoE report is related to a RVQoE configuration the UE received in another cell which is controlled by another gNB, and the UE has been in RRC_INACTIVE state at least at one point in time after it received the RVQoE configuration. As an option, this indication may be a more generic indication from which the UE can derive the above described specific information, e.g., an indication in the form of an explicit or implicit indication that the cell and/or gNB supports the RVQoE framework.
An indication that the gNB supports RVQoE measurement reporting (i.e., reception of a RVQoE measurement report from a UE) when the UE has been in RRC_IDLE state at least at one point in time after it received the RVQoE configuration. As an option, this indication may be a more generic indication from which the UE can derive the above described specific information, e.g., an indication in the form of an explicit or implicit indication that the cell and/or gNB supports the RVQoE framework.
Parameters related to QoE/RVQoE measurements for MBS, e.g. an MBS Service Area, MBS Session ID, TMGI, MBS Frequency Selection Area ID
Indications related to allowed-lists and not-allowed-lists (list of barred cells) for transmission of QoE reports. For example, cells, to which the UE may transmit QoE reports to, transmit an indication that the UE may transmit QoE reports to this cell. Alternatively, or additionally, cells which the UE may not transmit QoE reports to, transmit an indication that the UE may not transmit QoE report to this cell, i.e. the UE is barred from transmitting QoE reports to the cell.
An indication that the UE shall request to transit to RRC_CONNECTED state only for the reason to transmit QoE reports, even if there is no other reason to transit to RRC_CONNECTED. There may be one indication for regular QoE measurement reporting and one indication for RAN visible QoE measurement reporting.
An indication that the UE shall not request to transit to RRC_CONNECTED state only for the reason to transmit QoE reports, i.e. the UE shall wait with transmitting QoE reports until it transits to RRC_CONNECTED state for some other reason. There may be one indication for regular QoE measurement reporting and one indication for RAN visible QoE measurement reporting.

The method further comprises transmitting to a UE a message instructing the UE to transition from RRC_CONNECTED to RRC_INACTIVE (e.g., an RRCRelease message) comprising (e.g., as part of a SuspendConfig IE), one or more of the information as indicated above for the system information broadcast.

The method further comprises receiving from a UE performing cell reselection: information related to QoE, e.g., MCE address(es), MCE Identifier(s), QoE/RVQoE configuration parameters, QoE related event(s), QoE/RVQoE measurements. In one alternative, only receive the QoE related information from the UE if the network has indicated to the UE that it shall or may transmit the QoE related information. The network may indicate this to the UE in dedicated RRC signaling or by broadcasting it in system information.

The method further comprises receiving from a UE when returning to RRC_CONNECTED state, e.g., in an RRCResumeComplete message or an RRCSetupComplete message: an indication that the UE has QoE related information and/or RVQoE related information to transmit to the network, e.g., MCE address(es), MCE Identifier(s), QoE and/or RVQoE configuration parameters, information related to QoE related event(s), information related to RVQoE related event(s), QoE/RVQoE measurements report(s); and/or QoE related information and/or RVQoE related information, e.g. MCE address(es), MCE Identifier(s), QoE and/or RVQoE configuration parameters, information related to QoE related event(s), information related to RVQoE related event(s), QoE measurement report(s), and/or RVQoE measurement report(s).

Optionally, upon receiving the indication from the UE, the method comprises configuring SRB4 for the UE.

Optionally, the method comprises sending to the UE a request to send to the gNB the QoE related information the UE has indicated that it has available for transmission to the gNB. As one option, the network node does this only after having configured SRB4 for the UE.

Optionally, if the UE resumed to RRC_CONNECTED state from RRC_INACTIVE state, the network node may receive the QoE related information (except any QoE report(s)) from the UE's old serving gNB (i.e., the gNB that released the UE to RRC_INACTIVE state and which served as the anchor gNB while the UE was in RRC_INACTIVE state) during the context fetch procedure, instead of receiving this information from the UE.

Optionally, if the UE transited to RRC_CONNECTED state from RRC_IDLE state, the network node may receive the QoE related information (except any QoE report(s)) from the core network, e.g. from an AMF or an MME, e.g. in an INITIAL CONTEXT SETUP REQUEST NGAP message, instead of receiving this information from the UE.

The method further comprises receiving from a UE performing SDT with/without UE context relocation, e.g., in an RRCResumeRequest message or an RRCResumeRequest1 message, as part of uplink SDT data and/or up SDT signaling: an indication that the UE has QoE related and/or RVQoE related information to transmit to the network, e.g., MCE address(es), MCE Identifier(s), QoE and/or RVQoE configuration parameters, information related to QoE related event(s), information related to RVQoE related event(s), QoE/RVQoE measurements report(s); and/or QoE related information and/or RVQoE related information, e.g. MCE address(es), MCE Identifier(s), QoE and/or RVQoE configuration parameters, information related to QoE related event(s), information related to RVQoE related event(s), and/or QoE/RVQoE measurements report(s).

The actions above are separate actions which may be performed separately, i.e. one or multiple of the actions may be performed.

For UE mobility in RRC_CONNECTED state, the UE can receive from a gNB at least part of the QoE related information as detailed for the case of UE in RRC_IDLE/RRC_INACTIVE state.

A method may comprise receiving an RRC message instructing the UE to transition to RRC_INACTIVE (e.g., an RRCRelease message) comprising (e.g., as part of a SuspendConfig IE): one or more of the information as indicated above for the system information broadcast; and/or an indication of continuation of MBS-related QoE measurements when a UE transitions from an RRC CONNECTED state to RRC INACTIVE state upon mobility to the new cell when a UE already is in an MBS session. There may be an indication in the QoE configuration to continue QoE measurements when a UE enters an RRC INACTIVE state, and if the same MBS session continues in the target cell.

A gNB may send the information as part of an RRCReconfiguration message (or similar) sent during handover execution (comprising a handover command) or sent after handover execution is completed.

At handover execution, e.g. in RRCReconfigurationComplete, the UE may send to the selected target gNB: an indication that the UE has QoE related information to transmit to the network, e.g. MCE address(es), MCE Identifier(s), QoE/RVQoE configuration parameters, QoE related events, QoE/RVQoE measurements; and/or QoE related information.

For conditional handover, the source gNB may receive for any/all of the candidate target cells a piece of information comprising at least part of the QoE related information as detailed for the case of UE in RRC_IDLE/RRC_INACTIVE state.

Some embodiments include handover when a UE is receiving data and/or services via MBS session. Two aspects are considered on the UE handover from one gNB to the other gNB, when a UE is receiving data via MBS. One aspect is the target gNB support for the QoE measurements, and the second aspect is target gNB support for the MBS. Even when a target gNB may support QoE measurements, it may not support MBS. The following cases may be considered for the handover of the UE receiving MBS multicast session:

When the UE moves from a gNB that supports MBS to another gNB that supports MBS, include in the QoE measurement/report PDU Session ID, MRB ID, MBS Session ID, include the transmission method PTM or PTP.

When the UE moves from a gNB that supports MBS to a gNB that does not support MBS, but the same service can be delivered to a UE, the traffic delivery method will be changed and MRB will be reconfigured to DRB: include in the QoE measurement/report PDU Session ID, DRB ID, MBS Session ID, transmission method PTM or PTP.

Some embodiments include QoE measurements when a UE is handed over to a gNB supporting MBS. When the UE moves from a gNB that does not support MBS to a gNB that supports MBS: a UE may be receiving a service of a certain type via unicast/non-MBS delivery, and then may be handed over to the gNB that supports MBS multicast and therefore, after such handover the same service type may be delivered via MBS multicast if a UE is in RRC_CONNECTED, then QoE measurements may be continued and non-MBS to MBS service delivery type change may be indicated in the report (if indicating MBS as a service delivery type). Also the following may be indicated in the QoE report: the radio bearer reconfiguration from DRB to MRB; change from PTP to PTM indication; and/or as of now, MBS multicast is supported only for the RRC_CONNECTED state, therefore a UE in non-RRC_CONNECTED state cannot start receiving the MBS multicast session. Therefore, even though the QoE configuration may contain indications how UE should perform QoE measurements in non-RRC_CONNECTED states, the UE after handover may not start receiving the MBS multicast service if it is in non-RRC_CONNECTED state.

A UE may be receiving a service of a certain type via unicast/non-MBS delivery, and then may move to the area that supports MBS broadcast and therefore, after such handover the same service type may now be delivered via MBS broadcast independently of a UE's RRC state. The QoE measurements therefore may continue after this handover and the QoE report may include: a service delivery type from non-MBS to MBS service delivery type may be indicated (because the service type of an actual service delivered to a UE might have not changed); indication of reconfiguration of radio bearers from DRB to MRB; and/or indication of change from PTP to PTM.

The information above to be added to the QoE report may need to be transferred from the access stratum layer to the application layer within the UE. That may be done by means of AT commands as described above. That means that the indications listed above, e.g. indication of change from PTP to PTM, are added to existing or new AT commands.

Some embodiments include handover of a UE from a gNB supporting MBS to an eNB supporting MBMS. If the same MBS service is provided via eMBMS in E-UTRAN and MBS in 5G NR, the interworking is supported at the service layer, as described in 3GPP TS 23.247 clause 6.8. Therefore, if eNB supports QoE measurements, after handover to this eNB, the QoE measurements may continue according to LTE QoE baseline, at least when DASH and MTSI services are delivered via MBMS. according to UE capability.

Some embodiments include handover of a UE from an eNB supporting MBMS to a gNB supporting MBS. If the same MBS service is provided via MBS in 5G NR and eMBMS in E-UTRAN, the interworking is supported at the service layer, as described in 3GPP TS 23.247 clause 6.8. Therefore, if gNB supports QoE measurements, after handover to this gNB, the QoE measurements may continue according to NR QoE baseline, at least when DASH and MTSI services are delivered via MBMS. according to UE capability.

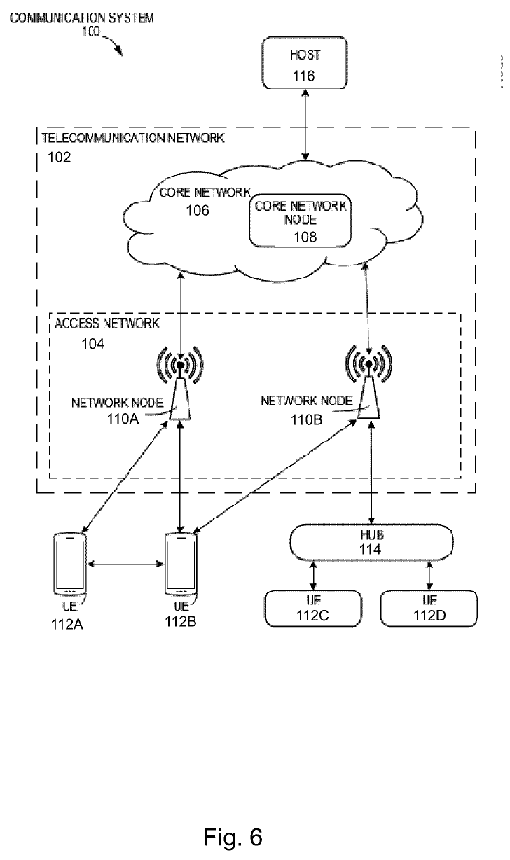

FIG. 6 illustrates an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more services. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

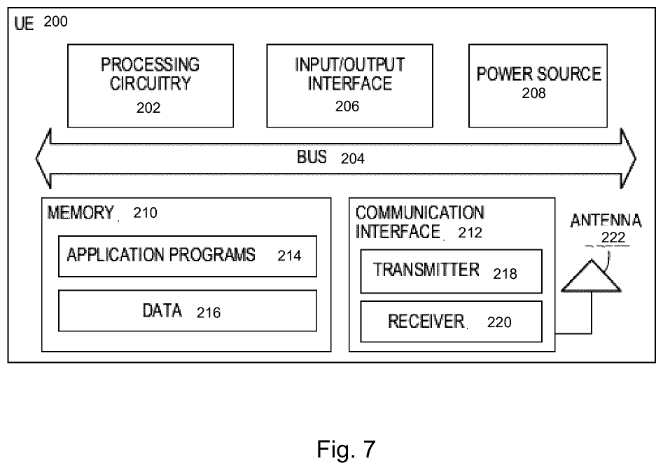

FIG. 7 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

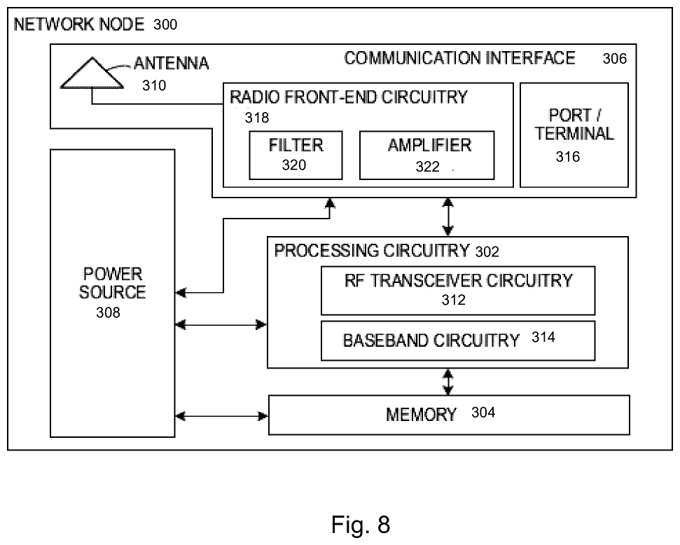

FIG. 8 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 8 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

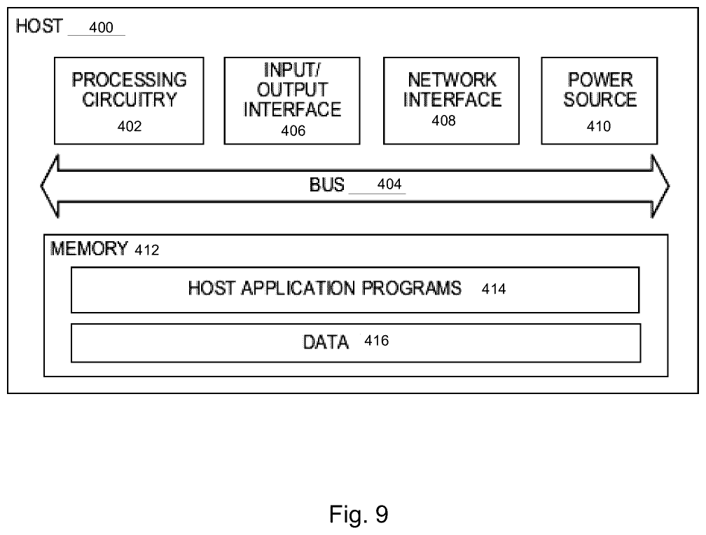

FIG. 9 is a block diagram of a host 400, which may be an embodiment of the host 116 of FIG. 6, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

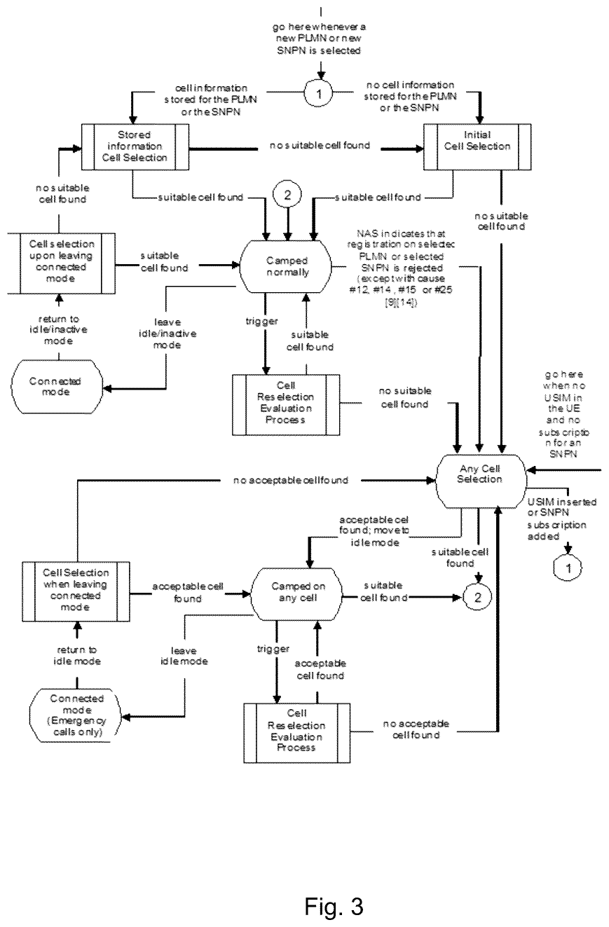

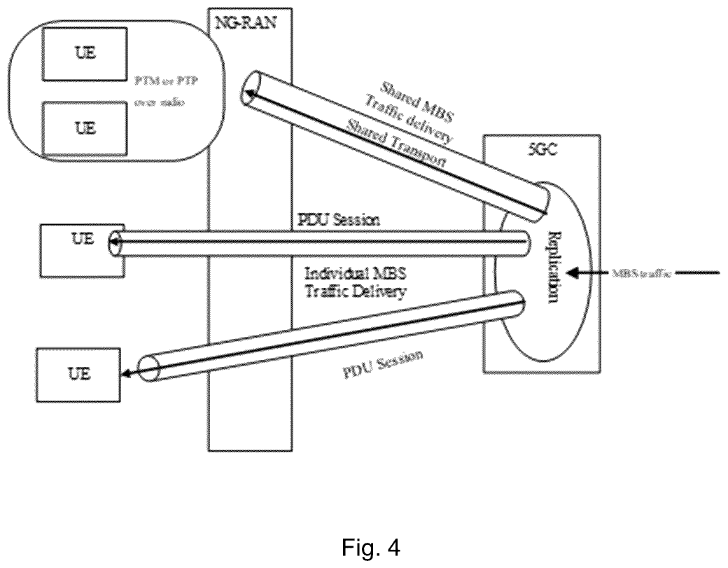

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 3 and 4, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

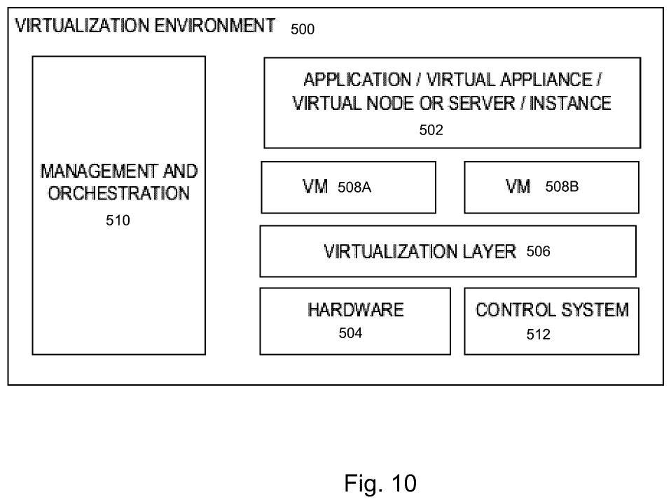

FIG. 10 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

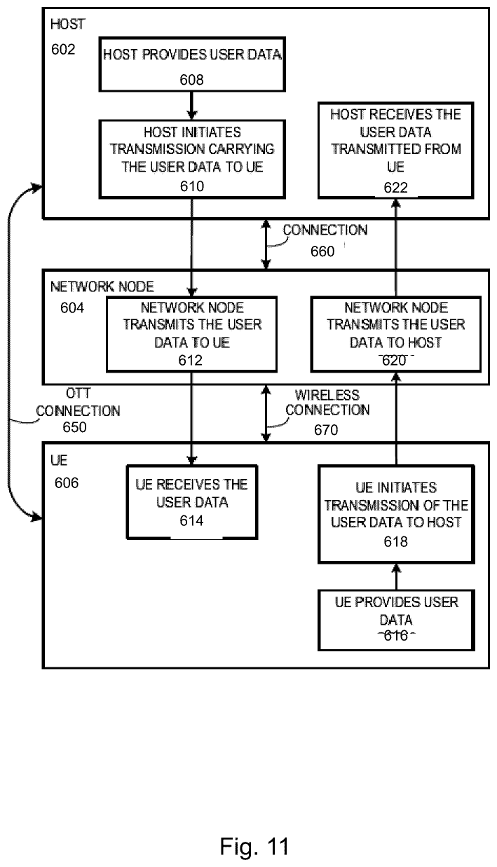

FIG. 11 shows a communication diagram of a host 602 communicating via a network node 604 with a UE 606 over a partially wireless connection in accordance with some embodiments. Example implementations, in accordance with various embodiments, of the UE (such as a UE 112a of FIG. 6 and/or UE 200 of FIG. 7), network node (such as network node 110a of FIG. 6 and/or network node 300 of FIG. 8), and host (such as host 116 of FIG. 6 and/or host 400 of FIG. 9) discussed in the preceding paragraphs will now be described with reference to FIG. 11.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 6) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the delay to directly activate an SCell by RRC and power consumption of user equipment and thereby provide benefits such as reduced user waiting time and extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

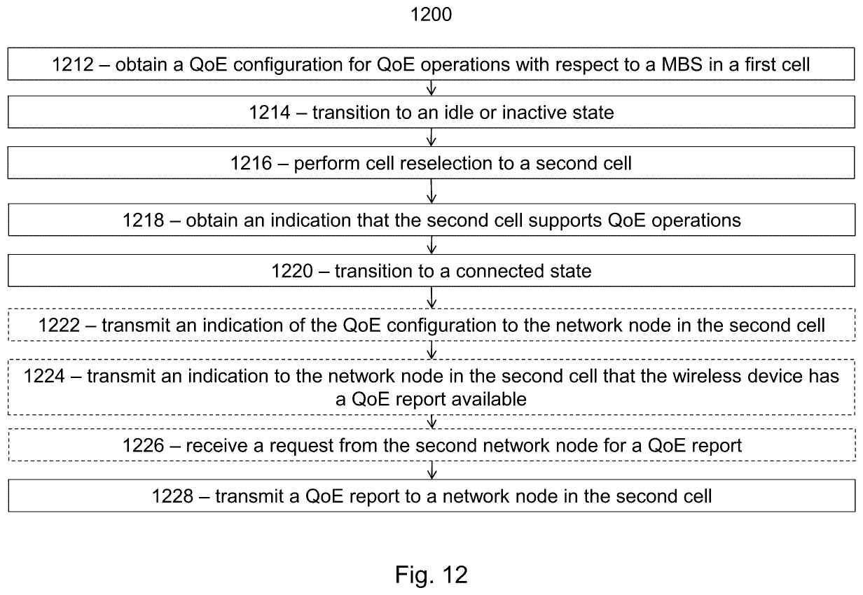

FIG. 12 is a flowchart illustrating an example method in a wireless device, according to certain embodiments. In particular embodiments, one or more steps of FIG. 12 may be performed by UE 200 described with respect to FIG. 7.

The method begins at step 1212, where the wireless device (e.g., UE 200) obtains a QoE configuration for QoE operations with respect to a MBS in a first cell of a first network node. For example, the wireless device may be configured for QoE operations according to any of the examples described above.

At step 1214, the wireless device transitions to an idle or inactive state. For example, the wireless device may transition to RRC_IDLE or RRC_INACTIVE.

While in the idle or inactive state, at step 1216, the wireless device performs cell reselection to a second cell of a second network node. A particular advantage of the embodiments described herein is that when the wireless device changes cell while in idle or inactive state, the wireless device may continue transmission of QoE measurement reports in the new (second) cell. In some embodiments, the first network node and the second network node may be the same network node.

At step 1218, the wireless device obtains an indication that the second cell supports QoE operations. In particular embodiments, obtaining the indication that the second cell supports QoE operations comprises receiving system information from the network node in the second cell. The indication that the second cell supports QoE operations may comprise any one or more of the following: an indication that the second cell supports one or more of QoE/RVQoE configuration, QoE/RVQoE measurement, and QoE/RVQoE reporting, an indication that the second cell supports SRB4; and/or an indication that the wireless device may use SDT for transmitting QoE/RVQoE reports. The indications may be explicit or implicit based on other supported features. In particular embodiments, the wireless device may obtain the indication according to any of the examples and embodiments described above.

At step 1220, the wireless device transitions to a connected state. For example, the wireless device may transition to RRC_CONNECTED. Based on the previous indication that the second cell supports QoE operation, after transitioning to connected, the method may continue to step 1222.

At step 1222, the wireless device may transmit an indication of the QoE configuration to the network node in the second cell. This optional step lets the second cell know that the wireless device is capable of QoE operation and its current configuration that the wireless device was configured with in the first cell.

If the wireless device has been performing QoE operations and has a QoE report available, the method may continue to step 1224, where the wireless device transmits an indication to the network node in the second cell that the wireless device has a QoE report available. Transmitting the indication to the network node in the second cell that the wireless device has a QoE report available may be based on a cause value for transitioning to the connected state (e.g., resume cause is rna-Update). Transmitting the indication to the network node in the second cell that the wireless device has a QoE report available may comprise transmitting a small data transmission (SDT).

In particular embodiments, the indication that the wireless device has a QoE report available may comprise any of the indications described with respect to the embodiments and examples described above.

At step 1226, the wireless device may receive a request from the second network node for a QoE report. The request may be in response to the indication from step 1224, or the request may be independent of any indication from the wireless device and may be based on, for example, a cause value for transitioning to the connected state, on the QoE configuration of the wireless device, and/or any other suitable event or condition.

At step 1228, the wireless device transmits a QoE report to the second network node in the second cell. The wireless device may transmit the QoE report according to any of the embodiments and examples described herein.

Modifications, additions, or omissions may be made to method 1200 of FIG. 12. Additionally, one or more steps in the method of FIG. 12 may be performed in parallel or in any suitable order.

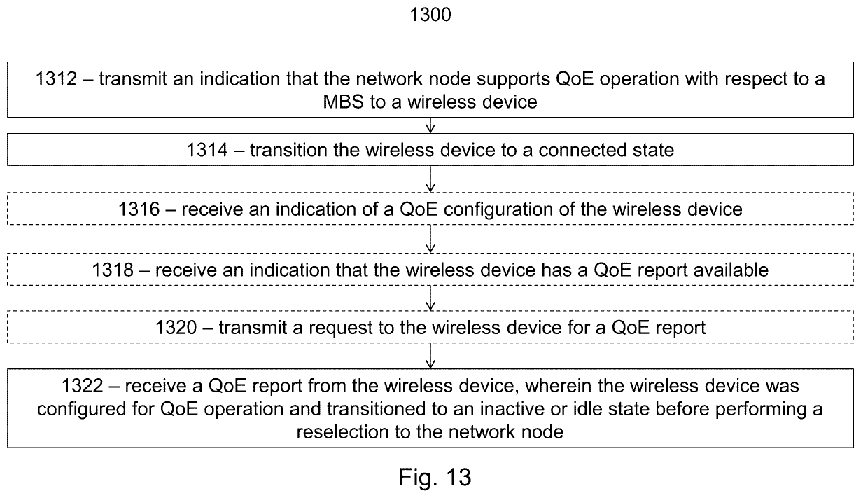

FIG. 13 is a flowchart illustrating an example method in a network node, according to certain embodiments. In particular embodiments, one or more steps of FIG. 13 may be performed by network node 300 described with respect to FIG. 8.

The method begins at step 1312, where the network node (e.g., network node 300) transmits an indication that the network node supports QoE operation with respect to a MBS to a wireless device. This may be because the wireless device was previously configured for QoE operation and transitioned to an inactive or idle state before performing a reselection to the second network node.

At step 1314, the second network node transitions the wireless device to a connected state. For example, the second network node transitions the wireless device to RRC_CONNECTED.

At step 1316, the network node may optionally receive an indication of a QoE configuration of the wireless device. The QoE configuration is described in more detail with respect to step 1222 of FIG. 12 and the embodiments and examples described above.

At step 1318, the network node may receive an indication that the wireless device has a QoE report available. The indication is described in more detail with respect to step 1224 of FIG. 12 and the embodiments and examples described above.

At step 1320, the network node may transmit a request to the wireless device for a QoE report. The network node may transmit the request according to any of the embodiments and examples described above.

At step 1322, the network node receives a QoE report from the wireless device. The network node may receive the QoE report according to any of the embodiments and examples described above.

Modifications, additions, or omissions may be made to method 1300 of FIG. 13. Additionally, one or more steps in the method of FIG. 13 may be performed in parallel or in any suitable order.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described connection with an embodiment, it is submitted that it is within the knowledge of one skilled the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

Some example embodiments are described below.
Group A Embodiments
   1. A method performed by a wireless device, the method comprising:
      obtaining a quality of experience (QoE) configuration for QoE operations with respect to a multicast or broadcast service (MBS) in a first cell;
      transitioning to an idle or inactive state;
      performing cell reselection to a second cell;
      obtaining an indication that the second cell supports QoE operations;
      transitioning to a connected state; and
      transmitting a QoE report to a network node in the second cell.
   2. The method of the previous embodiment, further comprising transmitting an indication of the QoE configuration to the network node in the second cell.
   3. The method of any one of the previous embodiments, further comprising transmitting an indication to the network node in the second cell that the wireless device has a QoE report available.
   4. The method of the previous embodiment, wherein transmitting the indication to the network node in the second cell that the wireless device has a QoE report available is based on a cause value for transitioning to the connected state.
   5. The method of any one of embodiments 3-4, wherein transmitting the indication to the network node in the second cell that the wireless device has a QoE report available comprises a small data transmission (SDT).
   6. The method of any one of the previous embodiments, wherein the QoE configuration comprises a RVQoE configuration.
   7. The method of any one of the previous embodiments, wherein the QoE configuration comprises any of the QoE configuration in the embodiments and examples described above.
   8. A method performed by a wireless device, the method comprising:
      any of the wireless device steps, features, or functions described above, either alone or in combination with other steps, features, or functions described above.
   9. The method of the previous embodiment, further comprising one or more additional wireless device steps, features or functions described above.
   10. The method of any of the previous embodiments, further comprising:
      providing user data; and
      forwarding the user data to a host computer via the transmission to the base station.
Group B Embodiments
   11. A method performed by a base station, the method comprising:
      transmitting an indication that the base station supports a quality of experience (QoE) operations with respect to a multicast or broadcast service (MBS) to a wireless device;
      transitioning the wireless device to a connected state; and
      receiving a QoE report from the wireless device.
   12. The method of the previous embodiment, further receiving an indication of a QoE configuration of the wireless device.
   13. The method of any one of embodiments 11-12, further comprising receiving an indication that the wireless device has a QoE report available.
   14. The method of the previous embodiment, wherein receiving the indication that the wireless device has a QoE report available is based on a cause value for transitioning to the connected state.
   15. The method of any one of embodiments 13-14, wherein receiving the indication that the wireless device has a QoE report available comprises receiving a small data transmission (SDT).
   16. The method of any one of the previous embodiments, wherein the QoE operation comprises a RVQoE operation.
   17. The method of any one of the previous embodiments, wherein the QoE configuration comprises any of the QoE operations in the embodiments and examples described above.
   18. A method performed by a base station, the method comprising:
      any of the steps, features, or functions described above with respect to base station, either alone or in combination with other steps, features, or functions described above.
   19. The method of the previous embodiment, further comprising one or more additional base station steps, features or functions described above.
   20. The method of any of the previous embodiments, further comprising:
      obtaining user data; and
      forwarding the user data to a host computer or a wireless device.
Group C Embodiments
   21. A mobile terminal comprising:
      processing circuitry configured to perform any of the steps of any of the Group A embodiments; and
      power supply circuitry configured to supply power to the wireless device.
   22. A base station comprising:
      processing circuitry configured to perform any of the steps of any of the Group B embodiments;
      power supply circuitry configured to supply power to the wireless device.
   23. A user equipment (UE) comprising:
      an antenna configured to send and receive wireless signals;
      radio front-end circuitry connected to the antenna and to processing circuitry, and configured to condition signals communicated between the antenna and the processing circuitry;
      the processing circuitry being configured to perform any of the steps of any of the Group A embodiments;
      an input interface connected to the processing circuitry and configured to allow input of information into the UE to be processed by the processing circuitry;
      an output interface connected to the processing circuitry and configured to output information from the UE that has been processed by the processing circuitry; and
      a battery connected to the processing circuitry and configured to supply power to the UE.
   24. A communication system including a host computer comprising:
      processing circuitry configured to provide user data; and
      a communication interface configured to forward the user data to a cellular network for transmission to a user equipment (UE),
      wherein the cellular network comprises a base station having a radio interface and processing circuitry, the base station's processing circuitry configured to perform any of the steps of any of the Group B embodiments.
   25. The communication system of the pervious embodiment further including the base station.
   26. The communication system of the previous 2 embodiments, further including the UE, wherein the UE is configured to communicate with the base station.
   27. The communication system of the previous 3 embodiments, wherein:
      the processing circuitry of the host computer is configured to execute a host application, thereby providing the user data; and
      the UE comprises processing circuitry configured to execute a client application associated with the host application.
   28. A method implemented in a communication system including a host computer, a base station and a user equipment (UE), the method comprising:
      at the host computer, providing user data; and
      at the host computer, initiating a transmission carrying the user data to the UE via a cellular network comprising the base station, wherein the base station performs any of the steps of any of the Group B embodiments.
   29. The method of the previous embodiment, further comprising, at the base station, transmitting the user data.
   30. The method of the previous 2 embodiments, wherein the user data is provided at the host computer by executing a host application, the method further comprising, at the UE, executing a client application associated with the host application.
   31. A user equipment (UE) configured to communicate with a base station, the UE comprising a radio interface and processing circuitry configured to performs any of the previous 3 embodiments.
   32. A communication system including a host computer comprising:
      processing circuitry configured to provide user data; and
      a communication interface configured to forward user data to a cellular network for transmission to a user equipment (UE),
      wherein the UE comprises a radio interface and processing circuitry, the UE's components configured to perform any of the steps of any of the Group A embodiments.
   33. The communication system of the previous embodiment, wherein the cellular network further includes a base station configured to communicate with the UE.
   34. The communication system of the previous 2 embodiments, wherein:
      the processing circuitry of the host computer is configured to execute a host application, thereby providing the user data; and
      the UE's processing circuitry is configured to execute a client application associated with the host application.
   35. A method implemented in a communication system including a host computer, a base station and a user equipment (UE), the method comprising:
      at the host computer, providing user data; and
      at the host computer, initiating a transmission carrying the user data to the UE via a cellular network comprising the base station, wherein the UE performs any of the steps of any of the Group A embodiments.
   36. The method of the previous embodiment, further comprising at the UE, receiving the user data from the base station.
   37. A communication system including a host computer comprising:
      communication interface configured to receive user data originating from a transmission from a user equipment (UE) to a base station,
      wherein the UE comprises a radio interface and processing circuitry, the UE's processing circuitry configured to perform any of the steps of any of the Group A embodiments.
   38. The communication system of the previous embodiment, further including the UE.
   39. The communication system of the previous 2 embodiments, further including the base station, wherein the base station comprises a radio interface configured to communicate with the UE and a communication interface configured to forward to the host computer the user data carried by a transmission from the UE to the base station.
   40. The communication system of the previous 3 embodiments, wherein:
      the processing circuitry of the host computer is configured to execute a host application; and
      the UE's processing circuitry is configured to execute a client application associated with the host application, thereby providing the user data.
   41. The communication system of the previous 4 embodiments, wherein:
      the processing circuitry of the host computer is configured to execute a host application, thereby providing request data; and
      the UE's processing circuitry is configured to execute a client application associated with the host application, thereby providing the user data in response to the request data.
   42. A method implemented in a communication system including a host computer, a base station and a user equipment (UE), the method comprising:
      at the host computer, receiving user data transmitted to the base station from the UE, wherein the UE performs any of the steps of any of the Group A embodiments.
   43. The method of the previous embodiment, further comprising, at the UE, providing the user data to the base station.
   44. The method of the previous 2 embodiments, further comprising:
      at the UE, executing a client application, thereby providing the user data to be transmitted; and
      at the host computer, executing a host application associated with the client application.
   45. The method of the previous 3 embodiments, further comprising:
      at the UE, executing a client application; and
      at the UE, receiving input data to the client application, the input data being provided at the host computer by executing a host application associated with the client application,
      wherein the user data to be transmitted is provided by the client application in response to the input data.
   46. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
   47. The communication system of the previous embodiment further including the base station.
   48. The communication system of the previous 2 embodiments, further including the UE, wherein the UE is configured to communicate with the base station.
   49. The communication system of the previous 3 embodiments, wherein:
      the processing circuitry of the host computer is configured to execute a host application;
      the UE is configured to execute a client application associated with the host application, thereby providing the user data to be received by the host computer.
   50. A method implemented in a communication system including a host computer, a base station and a user equipment (UE), the method comprising:
      at the host computer, receiving, from the base station, user data originating from a transmission which the base station has received from the UE, wherein the UE performs any of the steps of any of the Group A embodiments.
   51. The method of the previous embodiment, further comprising at the base station, receiving the user data from the UE.
   52. The method of the previous 2 embodiments, further comprising at the base station, initiating a transmission of the received user data to the host computer.

1. A method performed by a wireless device, the method comprising:
obtaining a quality of experience, QoE, configuration for QoE operations with respect to a multicast and broadcast service, MBS, in a first cell of a first network node;
transitioning to an idle or inactive state;
performing cell reselection to a second cell of a second network node;
obtaining an indication that the second cell supports QoE operations;
transitioning to a connected state; and
transmitting a QoE report to the second network node in the second cell.

2. The method of claim 1, further comprising transmitting an indication of the QoE configuration to the network node in the second cell.

3. The method of claim 1, further comprising transmitting an indication to the network node in the second cell that the wireless device has a QoE report available.

4. The method of claim 3, wherein transmitting the indication to the network node in the second cell that the wireless device has a QoE report available is based on a cause value for transitioning to the connected state.

5. The method of claim 3, wherein transmitting the indication to the network node in the second cell that the wireless device has a QoE report available comprises transmitting a small data transmission, SDT.

6.-9. (canceled)

10. A wireless device comprising processing circuitry operable to:
obtain a quality of experience, QoE, configuration for QoE operations with respect to a multicast and broadcast service, MBS, in a first cell of a first network node;
transition to an idle or inactive state;
perform cell reselection to a second cell of a second network node;
obtain an indication that the second cell supports QoE operations;
transition to a connected state; and
transmit a QoE report to the second network node in the second cell.

11.-18. (canceled)

19. A method performed by a network node, the method comprising:
transmitting an indication that the network node supports quality of experience, QoE, operation with respect to a multicast or broadcast service, MBS, to a wireless device;
transitioning the wireless device to a connected state; and
receiving a QoE report from the wireless device, wherein the wireless device was configured for QoE operation and transitioned to an inactive or idle state before performing a reselection to the network node.

20. The method of claim 19, further comprising receiving an indication of a QoE configuration of the wireless device.

21. The method of claim 19, further comprising receiving an indication that the wireless device has a QoE report available.

22. The method of claim 21, wherein receiving the indication that the wireless device has a QoE report available is based on a cause value for transitioning to the connected state.

23. The method of claim 21, wherein receiving the indication that the wireless device has a QoE report available comprises receiving a small data transmission, SDT.

24.-27. (canceled)

28. A network node comprising processing circuitry operable to:
transmit an indication that the network node supports quality of experience, QoE, operation with respect to a multicast or broadcast service, MBS, to a wireless device;
transition the wireless device to a connected state; and
receive a QoE report from the wireless device, wherein the wireless device was configured for QoE operation and transitioned to an inactive or idle state before performing a reselection to the network node.

29.-36. (canceled)
